(19) United States
(12) Patent Application Publication
(10) Pub. No.: US 2025/0095621 A1
(43) Pub. Date: Mar. 20, 2025

(54) COMPACT METAMATERIAL SOUND ISOLATION DEVICES AND ASSEMBLIES

(71) Applicants: Toyota Motor Engineering & Manufacturing North America, Inc., Plano, TX (US); Toyota Jidosha Kabushiki Kaisha, Toyota-shi Aichi-Ken (JP)

(72) Inventors: Xiaoshi Su, Ann Arbor, MI (US); Debasish Banerjee, Ann Arbor, MI (US); Tomohiro Miwa, Toyota-shi Aichi-Ken (JP); Miki Nakahara, Toyota-shi Aichi-Ken (JP); Reimi Emoto, Nagoya-Ahi Aichi-Ken (JP); Mizuki Sakamoto, Toyota-shi Aichi-Ken (JP); Toyohiro Sone, Handa-shi Aichi-Ken (JP)

(21) Appl. No.: 18/470,523

(22) Filed: Sep. 20, 2023

(51) Int. Cl. G10K 11/172

(52) U.S. Cl. CPC G10K 11/172

(57) ABSTRACT

An acoustic structure includes at least one coupled pair of Helmholtz resonators that have an inner wall, a first rectangular shaped Helmholtz resonator with a first inner volume on one side of and partially defined by the inner wall, and a second rectangular shaped Helmholtz resonator with a second inner volume on another side of and partially defined by the inner wall.

### TECHNICAL FIELD

The present disclosure relates to acoustic structures that provide or exhibit sound transmission loss and sound isolation.

### BACKGROUND

Noise pollution is an increasingly common issue across multiple environments. For example, low-frequency noise in motor vehicles is an issue related to passenger comfort. Also, sound from motors, large fans, and diesel engines, among other undesirable sounds, contribute to sound annoyance not only in the automotive industry, but also in various facets of daily life.

The present disclosure addresses issues related to sound absorption and improving sound transmission loss for acoustic structures across broad frequency ranges.

### SUMMARY

This section provides a general summary of the disclosure and is not a comprehensive disclosure of its full scope or all of its features.

In one form of the present disclosure, an acoustic structure includes at least one coupled pair of Helmholtz resonators that have an inner wall, a first rectangular shaped Helmholtz resonator with a first inner volume on one side of and partially defined by the inner wall, and a second rectangular shaped Helmholtz resonator with a second inner volume on another side of and partially defined by the inner wall.

In another form of the present disclosure, an acoustic structure includes at least one column of coupled pair of Helmholtz resonators that are spaced apart from each other. The coupled pair of Helmholtz resonators include a plurality of spaced apart inner walls, a plurality of first rectangular shaped Helmholtz resonators with a plurality of respective first inner volumes on one side of and partially defined by a respective inner wall, and a plurality of second rectangular shaped Helmholtz resonators with a plurality of respective second inner volumes on another side of and partially defined by the respective inner wall.

In still another form of the present disclosure, an acoustic structure includes a column of coupled pair of Helmholtz resonators that are spaced apart from each other. The coupled pair of Helmholtz resonators include a plurality of spaced apart inner walls, a plurality of first rectangular shaped Helmholtz resonators with a plurality of respective first inner volumes on one side of and partially defined by a respective inner wall, a first sidewall spaced apart from the respective inner wall, and a first flange extending from the first sidewall towards the respective inner wall. The coupled pair of Helmholtz resonators also include a plurality of second rectangular shaped Helmholtz resonators with a plurality of respective second inner volumes on another side of and partially defined by the respective inner wall, a second sidewall spaced apart from the respective inner wall, and a second flange extending from the second sidewall towards the respective inner wall.

Further areas of applicability and various methods of enhancing the disclosed technology will become apparent from the description provided herein. The description and specific examples in this summary are intended for illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A shows a perspective view of an acoustic structure with a coupled pair of Helmholtz resonators according to one form of the present disclosure;

FIG. 1B shows a top view of the acoustic structure in FIG. 1A;

FIG. 2 shows a top view of an acoustic structure according to another form of the present disclosure;

FIG. 3 shows a top view of an acoustic structure according to still another form of the present disclosure;

FIG. 4A shows a column according to the teachings of the present disclosure with a plurality of the acoustic structures shown in FIG. 1B;

FIG. 4B shows a column according to the teachings of the present disclosure with a plurality of the acoustic structures shown in FIG. 2;

FIG. 4C shows a column according to the teachings of the present disclosure with a plurality of the acoustic structures shown in FIG. 3;

FIG. 5A is a graphical plot of sound transmission loss (STL) as a function of acoustic wave frequency for acoustic waves propagating through the column of acoustic structures shown in FIG. 4A;

FIG. 5B is a graphical plot of STL as a function of acoustic wave frequency for acoustic waves propagating through the column of acoustic structures shown in FIG. 4B;

FIG. 5C is a graphical plot of STL as a function of acoustic wave frequency for acoustic waves propagating through the column of acoustic structures shown in FIG. 4C; and

FIG. 6 is graphical plot of absorption, transmission, and reflection as a function of acoustic wave frequency for the column of acoustic structures shown in FIG. 4A.

It should be noted that the figures set forth herein are intended to exemplify the general characteristics of the chemical compounds, materials, and catalysts among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a sound isolation and sound transmission loss structure, also known as an acoustic structure, with at least one coupled pair of Helmholtz resonators. As used herein, the phrase “couple pair” refers to two Helmholtz resonators oppositely disposed on and sharing an inner wall that partially defines an inner volume of each of the two Helmholtz resonators. Stated differently, the two Helmholtz resonators share an inner wall with one of the Helmholtz resonators on one side of the inner wall and the other Helmholtz resonator on an opposite side of the inner wall.

In some variations, the coupled pair of Helmholtz resonators is a coupled pair of rectangular shaped Helmholtz resonators. And in such variations, a plurality of the coupled pair of Helmholtz resonators can be assembled into a compact acoustic structure. For example, two, three, or more, of the coupled pair of Helmholtz resonators according to the teachings of the present disclosure can be assembled into or manufactured as a single unit, and such units can be arranged in a column or row such that sound propagating through a given space or passageway is isolated.

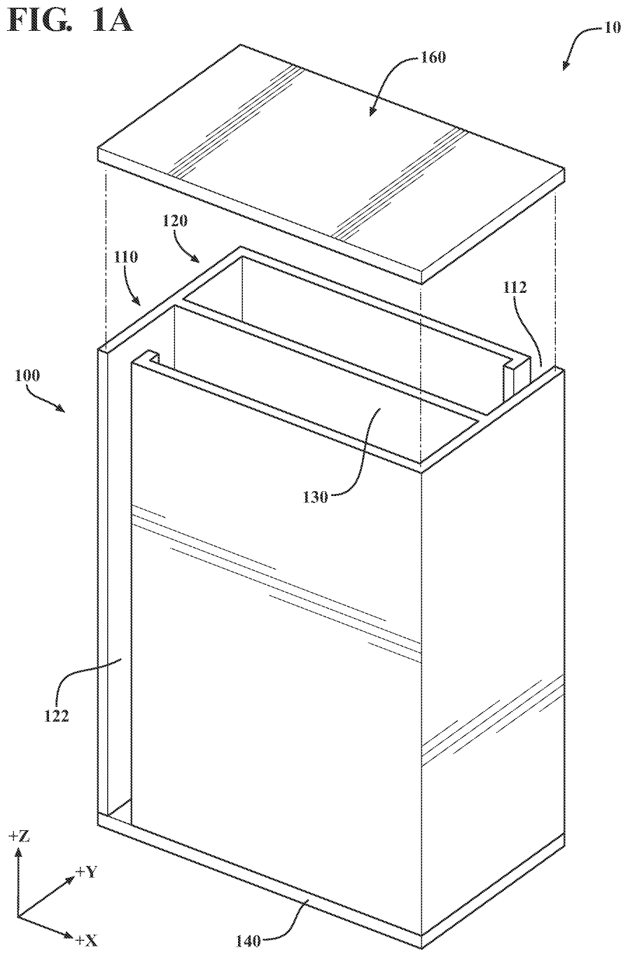

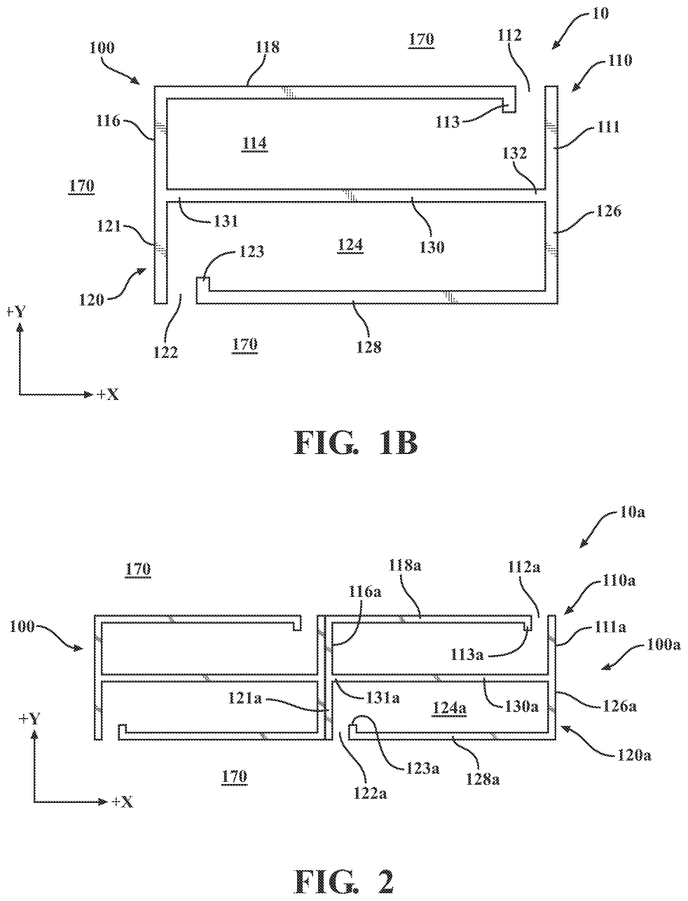

Referring to FIGS. 1A-1B, a perspective view of an acoustic structure 10 according to one form of the present disclosure is shown in FIG. 1A and a top view (−z direction) of the acoustic structure 10 is shown in FIG. 1B (end plates 140, 160 not shown). The acoustic structure 10 includes a coupled pair of Helmholtz resonators 100 formed from a first rectangular shaped Helmholtz resonator 110 and a second rectangular shaped Helmholtz resonator 120 attached or coupled to each other. The first rectangular shaped Helmholtz resonator 110 and the second rectangular shaped Helmholtz resonator 120 share an inner wall 130 that at least partially defines an inner volume 114 (FIG. 1B) of the first rectangular shaped Helmholtz resonator 110 and an inner volume 124 (FIG. 1B) of the second rectangular shaped Helmholtz resonator 120. The inner wall 130 isolates or completely separates the inner volume 114 from the inner volume 124, and while the inner wall 130 illustrated in the figures shows only one layer of solid material, in some variations the inner wall 130 includes two or more layers of solid, liquid, and/or gas material. In some variations, the first rectangular shaped Helmholtz resonator 110 and the second rectangular shaped Helmholtz resonator 120 also share end plates 140 and 160 (FIG. 1A) that may be flat structures made of an acoustically hard material, such as metal, glass, wood, or plastic.

In addition to the inner wall 130, the first rectangular shaped Helmholtz resonator 110 includes a first side wall 118 spaced apart from and extending generally parallel to the inner wall 130, a first neck wall 111 extending from a second end 132 of the inner wall 130, and a first end wall 116 extending from a first end 131 of the inner wall 130 to the first side wall 118. Also, a first flange 113 extends from the first side wall 118 towards the inner wall 130 such that a first neck 112 that provides fluid communication between the inner volume 114 and an exterior space 170 is defined between the first neck wall 111 and the first flange 113.

Similarly, the second rectangular shaped Helmholtz resonator 120 includes a second side wall 128 spaced apart from and extending generally parallel to the inner wall 130, a second neck wall 121 extending from the first end 131 of the inner wall 130, and a second end wall 126 extending from the second end 132 of the inner wall 130 to the second side wall 128. In addition, a second flange 123 extends from the second side wall 128 towards the inner wall 130 such that a second neck 122 that provides fluid communication between the inner volume 124 and the exterior space 170 is defined between the second neck wall 121 and the second flange 123.

Not being bound by theory, and as a first approximation, the resonant frequency (fₒ) of the first rectangular shaped Helmholtz resonator 110, and other rectangular shaped Helmholtz resonators disclosed herein, is described or given by the equation:

$${f}_{o} = c / 2 π \cdot \sqrt{\frac{{A}_{o}}{V \cdot {L}_{o}}} \qquad Eq . 1$$

where c is the speed of sound in air, Aₒ is the cross-sectional area of the neck (e.g., the first neck 112), V is the volume of the inner volume (e.g., the inner volume 114), and Lₒ is the length of the neck. And while the figures illustrate the first rectangular shaped Helmholtz resonator 110 and the second rectangular shaped Helmholtz resonator 120 having the same size, i.e., the same Aₒ, V, and Lₒ, in some variations the first rectangular shaped Helmholtz resonator 110 and the second rectangular shaped Helmholtz resonator 120 do not have the same size and thus have different resonant frequencies.

It should be understood that the first rectangular shaped Helmholtz resonator 110 and the second rectangular shaped Helmholtz resonator 120 function as acoustic impedance to acoustic waves, at and near their resonant frequency fₒ, propagating past or over the first neck 112 and the second neck 122, respectively.

Referring to FIG. 2, a top view (−z direction) of another acoustic structure 10a (end plates not shown) with a two-pack of coupled pair of Helmholtz resonators is shown. As used herein, the phrase “two-pack” refers to four (4) Helmholtz resonators coupled or positioned together as a first pair of Helmholtz resonators and a second pair of Helmholtz resonators. For example, the acoustic structure 10a includes the coupled pair of Helmholtz resonators 100 (also referred to herein as the “first coupled pair of Helmholtz resonators 100”) and a second coupled pair of Helmholtz resonators 100a. Corresponding features of the second coupled pair of Helmholtz resonators 100a with respect to the first coupled pair of Helmholtz resonators 100 are referenced with identical numeric numbers with the addition of “a.” For example, the second coupled pair of Helmholtz resonators 100a includes an inner wall 130a, a first neck 112a, a second neck 122a, etc.

In some variations, the second coupled pair of Helmholtz resonators 100a are coupled, either permanently or semi-permanently, with the first coupled pair of Helmholtz resonators 100 as illustrated in FIG. 2, while in other variations, the second coupled pair of Helmholtz resonators 100a are not coupled with the first coupled pair of Helmholtz resonators 100 (not shown). For example, in some variations the second coupled pair of Helmholtz resonators 100a are simply positioned and/or secured adjacent to the first coupled pair of Helmholtz resonators 100, while in other variations the second coupled pair of Helmholtz resonators 100a are physically attached to the first coupled pair of Helmholtz resonators 100 via welding, adhesives, and/or mechanical fasteners. And in at least one variation, the second coupled pair of Helmholtz resonators 100a and the first coupled pair of Helmholtz resonators 100 are formed as a single monolithic unit.

In some variations, the second coupled pair of Helmholtz resonators 100a share the first neck wall 111 (FIG. 1B) and the second end wall 126 (FIG. 1B) of the first coupled pair of Helmholtz resonators 100. That is, the first neck wall 111 of the first rectangular shaped Helmholtz resonator 110 is the same member or wall as the first end wall 116a of the first rectangular shaped Helmholtz resonator 110a and the second end wall 126 of the second rectangular shaped Helmholtz resonator 120 is the same wall as the second neck wall 121a of the second rectangular shaped Helmholtz resonator 120a. However, and as illustrated in FIG. 2, in at least one variation the first neck wall 111 of the first rectangular shaped Helmholtz resonator 110 is not the same member or wall as the first end wall 116a of the first rectangular shaped Helmholtz resonator 110a and/or the second end wall 126 of the second rectangular shaped Helmholtz resonator 120 is not the same wall as the second neck wall 121a of the second rectangular shaped Helmholtz resonator 120a.

Still referring to FIG. 2, in some variations the second coupled pair of Helmholtz resonators 100a are identical in shape and size as the first coupled pair of Helmholtz resonators 100. However, in at least one variation the second coupled pair of Helmholtz resonators 100a are not identical in shape and size as the first coupled pair of Helmholtz resonators 100. For example, in some variations the second coupled pair of Helmholtz resonators 100a are wider or narrower (x-direction) than the first coupled pair of Helmholtz resonators 100 and/or thinner or thicker (y-direction) than the coupled pair of Helmholtz resonators 100.

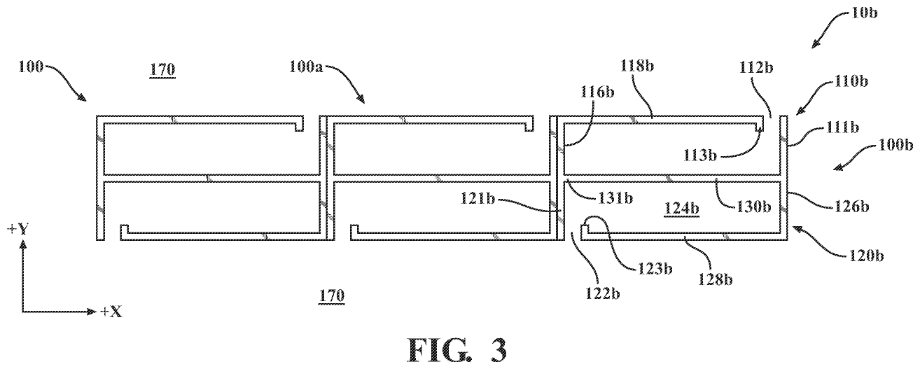

Referring to FIG. 3, a top view (−z direction) of still another acoustic structure 10b (end plates not shown) with a “three-pack” of coupled pair of Helmholtz resonators is shown. As used herein, the phrase “three-pack” refers to six (6) Helmholtz resonators coupled or positioned together as a first pair of Helmholtz resonators, a second pair of Helmholtz resonators, and a third pair of Helmholtz resonators. For example, the acoustic structure 10b includes the first coupled pair of Helmholtz resonators 100, the second coupled pair of Helmholtz resonators 100a, and a third coupled pair of Helmholtz resonators 100b. Corresponding features of the third coupled pair of Helmholtz resonators 100b with respect to the first coupled pair of Helmholtz resonators 100 are referenced with identical numeric numbers with the addition of “b.” For example, the third coupled pair of Helmholtz resonators 100b includes an inner wall 130b, a first neck 112b, a second neck 122b, etc.

In some variations, the third coupled pair of Helmholtz resonators 100b are coupled, either permanently or semi-permanently, with the second coupled pair of Helmholtz resonators 100a as illustrated in FIG. 3, while in other variations, the third coupled pair of Helmholtz resonators 100b are not coupled with the second coupled pair of Helmholtz resonators 100a (not shown). For example, in some variations the third coupled pair of Helmholtz resonators 100b are simply positioned and/or secured adjacent to the second coupled pair of Helmholtz resonators 100a, while in other variations the third coupled pair of Helmholtz resonators 100b are physically attached to the second coupled pair of Helmholtz resonators 100a via welding, adhesives, and/or mechanical fasteners. And in at least one variation, the third coupled pair of Helmholtz resonators 100a, the second coupled pair of Helmholtz resonators 100a, and the first coupled pair of Helmholtz resonators 100 are formed as a single monolithic unit.

In some variations, the third coupled pair of Helmholtz resonators 100b share the first neck wall 111a (FIG. 2) and the second end wall 126a (FIG. 2) of the second coupled pair of Helmholtz resonators 100a. That is, the first neck wall 111a of the first rectangular shaped Helmholtz resonator 110a is the same member or wall as the first end wall 116b of the first rectangular shaped Helmholtz resonator 110b and the second end wall 126a of the second rectangular shaped Helmholtz resonator 120a is the same wall as the second neck wall 121b of the second rectangular shaped Helmholtz resonator 120b. However, and as illustrated in FIG. 3, in at least one variation the first neck wall 111a of the first rectangular shaped Helmholtz resonator 110a is not the same member or wall as the first end wall 116b of the first rectangular shaped Helmholtz resonator 110b and the second end wall 126a of the second rectangular shaped Helmholtz resonator 120a is not the same wall as the second neck wall 121b of the second rectangular shaped Helmholtz resonator 120b.

Still referring to FIG. 3, in some variations the third coupled pair of Helmholtz resonators 100b are identical in shape and size as the second coupled pair of Helmholtz resonators 100a and/or the first coupled pair of Helmholtz resonators 100. However, in at least one variation the third coupled pair of Helmholtz resonators 100b are not identical in shape and size as the second coupled pair of Helmholtz resonators 100a and/or the first coupled pair of Helmholtz resonators 100. For example, in some variations the third coupled pair of Helmholtz resonators 100b are wider or narrower (x-direction) than the second coupled pair of Helmholtz resonators 100a and/or the first coupled pair of Helmholtz resonators 100, and/or thinner or thicker (y-direction) than the second coupled pair of Helmholtz resonators 100a and/or the first coupled pair of Helmholtz resonators 100.

It should be understood that the geometric or physical shapes of the rectangular shaped Helmholtz resonators provides for compact acoustic structures as illustrated in FIGS. 2 and 3. Stated differently, the shape of the rectangular shaped Helmholtz resonators according to the teachings of the present disclosure provide for a plurality of rectangular shaped Helmholtz resonators to be positioned and/or assembled directly adjacent and in direct contact with each other without wasted or unused space therebetween.

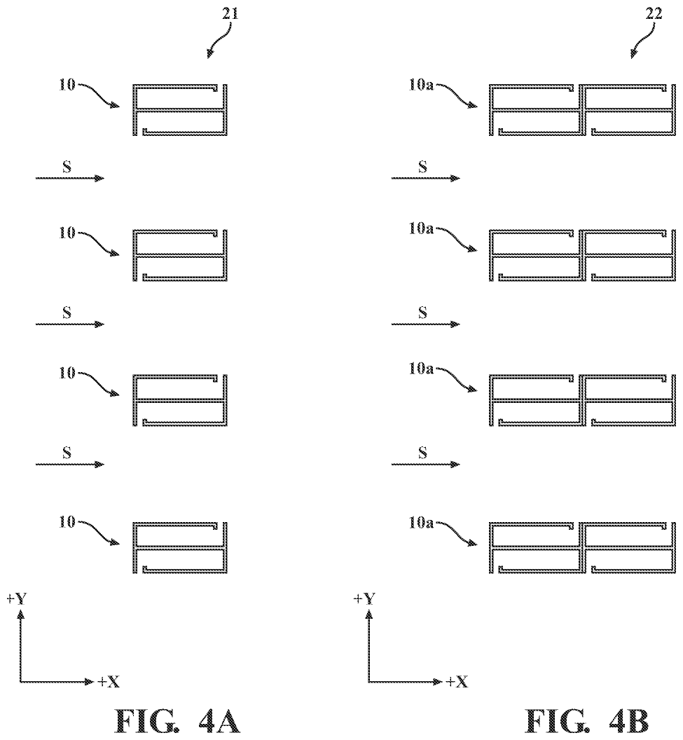

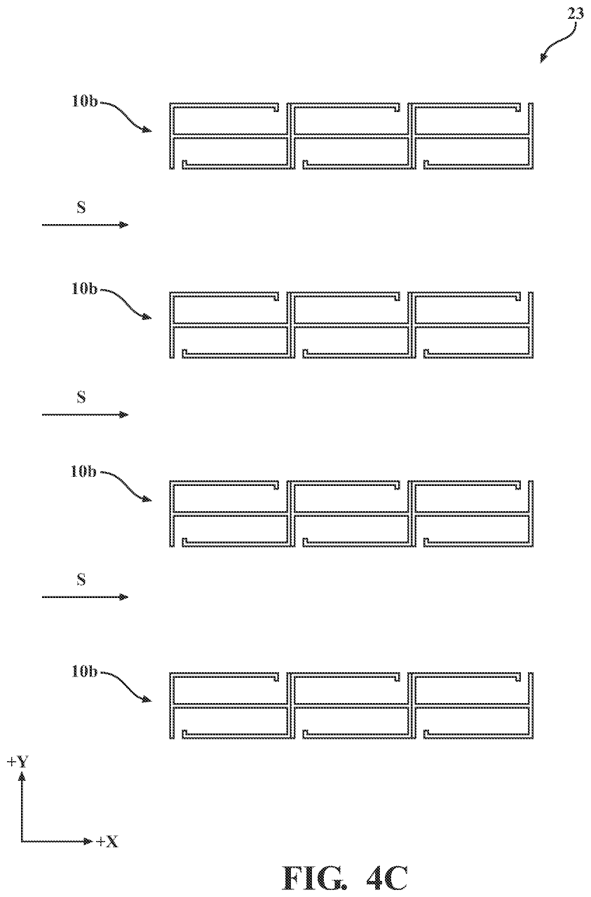

Referring to FIGS. 4A-4C, an assembly 21 of a plurality of the acoustic structures 10 (also referred to herein simply as “acoustic structures 10”) is shown in FIG. 4A, an assembly 22 of a plurality of the acoustic structures 10a (also referred to herein simply as “acoustic structures 10a”) is shown in FIG. 4B, and an assembly 23 of a plurality of the acoustic structures 10b (also referred to herein simply as “acoustic structures 10b”) is shown in FIG. 4C. The acoustic structures 10, 10a, and 10b are aligned and spaced apart from each other vertically (y-direction) such that acoustic waves ‘S’ propagating in the x-direction shown in the figures propagate across the first and second necks 112, 122, the first and second necks 112a, 122a, and the first and second necks 112b, 122b, respectively. In addition, the Helmholtz resonators provide STL of the acoustic waves as described in greater detail below. And while FIGS. 4A-4C illustrates the acoustic structures 10, 10a, and 10b aligned vertically, in some variations, the acoustic structures 10, 10a, and/or 10b are not aligned vertically. For example, in at least one variation one or more of the acoustic structures 10, 10a, and/or 10b are offset from each other in the x-direction shown in FIGS. 4A-4C, respectively. Also, it should be understood that while FIGS. 4A-4C illustrates the assemblies 21, 22, and 23 with four acoustic structures 10, 10a, 10b, respectively, in some variations the assembly 21, 22, and/or 23 includes less than four or more than four acoustic structures 10, 10a, 10b, respectively.

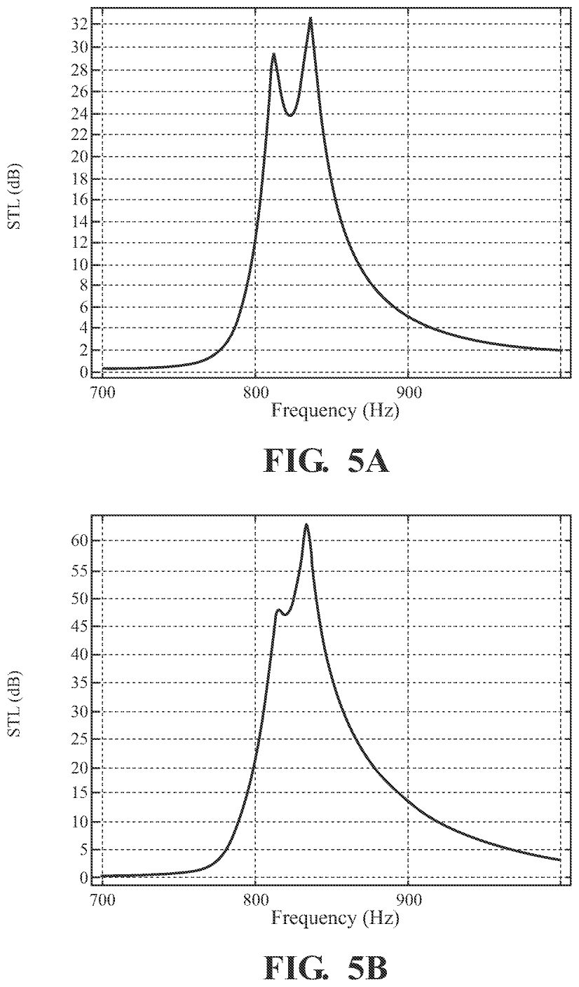

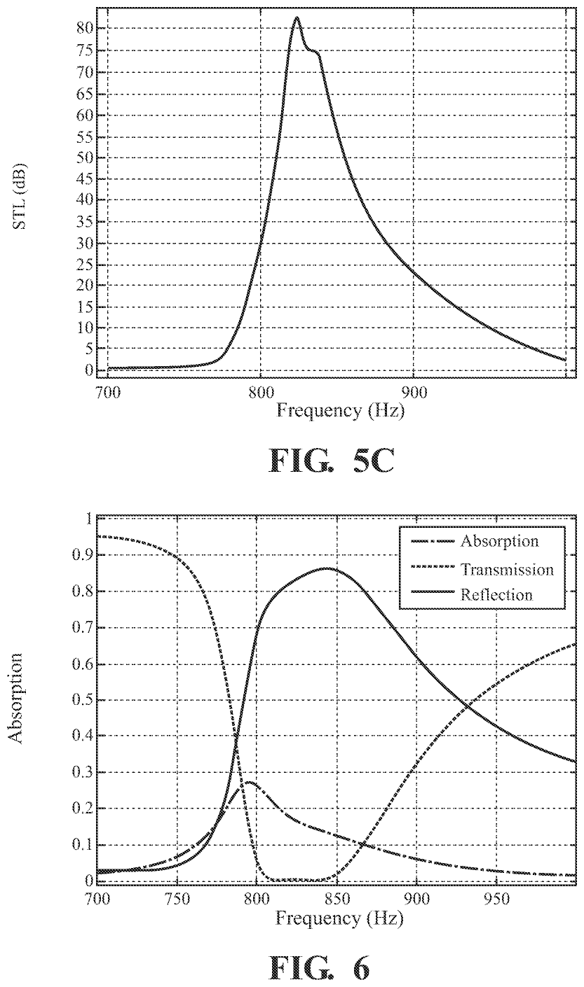

Referring to FIG. 5A, acoustic behavior of the assembly 21 illustrated in FIG. 4A is shown. Particularly, a graphical plot of simulated STL as a function of acoustic wave frequency is shown for acoustic waves S propagating in the +x direction and through the assembly 21. As observed from FIG. 5A, the assembly 21 exhibits STL peaks at about 810 Hz and about 835 Hz and it should be understood that the dual STL peaks broaden the frequency range of STL. For example, the assembly 21 exhibited an STL of 20 dB between about 805 Hz and about 845 Hz.

Referring to FIG. 5B, acoustic behavior of the assembly 22 illustrated in FIG. 4B is shown. Particularly, a graphical plot of simulated STL as a function of acoustic wave frequency is shown for acoustic waves S propagating in the +x direction and through the assembly 22. As observed from FIG. 5B, the assembly 22 exhibits STL peaks at about 815 Hz and about 830 Hz, an STL of 20 dB between about 800 Hz and about 880 Hz, and an STL of about 30 dB between about 805 Hz and about 850 Hz. Accordingly, the assembly 22 provides broader bandwidth (frequency range) STL compared to assembly 21.

Referring to FIG. 5C, acoustic behavior of the assembly 23 shown in FIG. 4C is shown. Particularly, a graphical plot of simulated STL as a function of acoustic wave frequency is shown for acoustic waves S propagating in the +x direction and through the assembly 23 shown in FIG. 4C. As observed from FIG. 5C, the assembly 23 exhibits an STL peak at about 825 Hz, an STL of 20 dB between about 795 Hz and about 910 Hz, and an STL of about 30 dB between about 800 Hz and about 880 Hz. Accordingly, the assembly 22 provides broader bandwidth (frequency range) STL compared to assemblies 21 and 22.

Referring to FIG. 6, absorption, transmission, and reflection by the assembly 21 shown in FIG. 4A is shown. Particularly, a graphical plot of simulated absorption, transmission, and reflection as a function of acoustic wave frequency is shown for acoustic waves S propagating in the +x direction and through the assembly 21. As observed in FIG. 6, transmission of acoustic waves with frequencies between about 800 Hz and about 850 Hz was about zero and it evident that the high STL or low transmission is due to the combination of absorption and reflection.

It should be understood that variations in the types of scatterers used, the arrangement, and spacing within an acoustic structure may produce varied levels of sound absorption and transmission loss. In addition, varying the size of acoustic scatterers within acoustic structures containing multiple scatterers may improve the aggregate frequencies absorbed and improve transmission loss more than acoustic structures containing a single sized acoustic scatterer because the aggregate resonant frequencies are broader when multiple sized scatterers are present in a structure than when identically sized acoustic scatterers are present. Moreover, varying the arrangement and spacing between acoustic scatterers within an acoustic structure may alter the sound absorbed and STL of the structure.

Each acoustic structure may vary in its arrangement of plate-coupled acoustic structures. Angle independent acoustic structures are preferably, but not exclusively, arranged in a manner that maximizes the absorption and transmission loss of undesirable sounds. Nonetheless, particularly where a sound originates from a single direction it may be economically beneficial to use both angle dependent acoustic scatterers and the angle independent acoustic scatterers together in the same acoustic structures. Angle independent acoustic scatterers, as disclosed herein, have at least two distinct resonant channels within repeated cells while angle dependent acoustic scatterers do not require such intricacies.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “include”, “includes”, and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms and variations. Therefore, while this disclosure includes particular examples, the true scope of the disclosure should not be so limited since other modifications will become apparent to the skilled practitioner upon a study of the specification and the following claims. Reference herein to one form or variation, or various forms or variations means that a particular feature, structure, or characteristic described in connection with a form, variation, or particular system is included in at least one form or variation. The appearances of the phrase “in one form” (or variations thereof) are not necessarily referring to the same form.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

1. An acoustic structure comprising:
at least one coupled pair of Helmholtz resonators comprising:
an inner wall;
a first rectangular shaped Helmholtz resonator having a first inner volume on one side of and partially defined by the inner wall; and
a second rectangular shaped Helmholtz resonator having a second inner volume on another side of and partially defined by the inner wall.

2. The acoustic structure according to claim 1, wherein the inner wall has a first end and a second end oppositely disposed from the second end, the first rectangular shaped Helmholtz resonator comprises a first neck proximal to the second end of the inner wall, and the second rectangular shaped Helmholtz resonator comprises a second neck proximal to the first end of the inner wall.

3. The acoustic structure according to claim 1, wherein the first rectangular shaped Helmholtz resonator comprises a first sidewall spaced apart from the inner wall and a first flange extending from the first sidewall towards the inner wall, and the second rectangular shaped Helmholtz resonator comprises a second sidewall spaced apart from the inner wall and a second flange extending from the second sidewall towards the inner wall.

4. The acoustic structure according to claim 3, wherein the first rectangular shaped Helmholtz resonator comprises a first neck defined between a first end wall extending from the inner wall and the first flange and the second rectangular shaped Helmholtz resonator comprises a second neck defined between a second end wall extending from the inner wall and the second flange.

5. The acoustic structure according to claim 1, wherein:
the inner wall has a first end and a second end oppositely disposed from the second end;
the first rectangular shaped Helmholtz resonator comprises a first end wall extending from the second end of the inner wall and a first side wall spaced apart from the inner wall and extending from the first end wall; and
the second rectangular shaped Helmholtz resonator comprises a second end wall extending from the first end of the inner wall and a second side wall spaced apart from the inner wall and extending from the second end wall.

6. The acoustic structure according to claim 5, wherein the first rectangular shaped Helmholtz resonator comprises a first flange extending from the first side wall towards the inner wall and the second rectangular shaped Helmholtz resonator comprises a second flange extending from the second side wall towards the inner wall.

7. The acoustic structure according to claim 6, wherein the first rectangular shaped Helmholtz resonator comprises a first neck wall extending from the first end of the inner wall and spaced apart from the first flange, the second rectangular shaped Helmholtz resonator comprises a second neck wall extending from the second end of the inner wall and spaced apart from the second flange.

8. The acoustic structure according to claim 7, wherein the first rectangular shaped Helmholtz resonator comprises a first neck defined between the first neck wall and the first flange and the second rectangular shaped Helmholtz resonator comprises a second neck defined between the second neck wall and the second flange.

9. The acoustic structure according to claim 1, wherein the at least one coupled pair of Helmholtz resonators comprises a plurality of coupled pair of Helmholtz resonators spaced apart from and aligned parallel with each other.

10. The acoustic structure according to claim 9, wherein the plurality of coupled pair of Helmholtz resonators define a column of coupled pair of Helmholtz resonators.

11. The acoustic structure according to claim 10, wherein the column of coupled pair of Helmholtz resonators is a plurality of two-pack coupled pair of Helmholtz resonators.

12. The acoustic structure according to claim 11, wherein individual two-pack coupled pair of Helmholtz resonators are directly attached to each other.

13. The acoustic structure according to claim 10, wherein the column of coupled pair of Helmholtz resonators is a plurality of three-pack coupled pair of Helmholtz resonators.

14. The acoustic structure according to claim 13, wherein individual three-pack coupled pair of Helmholtz resonators are directly attached to each other.

15. An acoustic structure comprising:
at least one column of spaced apart coupled pair of Helmholtz resonators comprising:
a plurality of spaced apart inner walls;
a plurality of first rectangular shaped Helmholtz resonators having a plurality of respective first inner volumes on one side of and partially defined by a respective inner wall; and
a plurality of second rectangular shaped Helmholtz resonators having a plurality of respective second inner volumes on another side of and partially defined by the respective inner wall.

16. The acoustic structure according to claim 15, wherein each of the coupled pair of Helmholtz resonators comprises one of the plurality of spaced apart inner walls, one of the plurality of first rectangular shaped Helmholtz resonators, and one plurality of second rectangular shaped Helmholtz resonators.

17. The acoustic structure according to claim 15, wherein the at least one column of spaced apart coupled pair of Helmholtz resonators comprises a column of two-pack coupled pair of Helmholtz resonators.

18. The acoustic structure according to claim 15, wherein the at least one column of spaced apart coupled pair of Helmholtz resonators comprises a column of three-pack coupled pair of Helmholtz resonators.

19. An acoustic structure comprising:
a column of spaced apart coupled pair of Helmholtz resonators comprising:
a plurality of spaced apart inner walls;
a plurality of first rectangular shaped Helmholtz resonators having a plurality of respective first inner volumes on one side of and partially defined by a respective inner wall, a first sidewall spaced apart from the respective inner wall, and a first flange extending from the first sidewall towards the respective inner wall; and
a plurality of second rectangular shaped Helmholtz resonators having a plurality of respective second inner volumes on another side of and partially defined by the respective inner wall, a second sidewall spaced apart from the respective inner wall, and a second flange extending from the second sidewall towards the respective inner wall.

20. The acoustic structure according to claim 19, wherein:
each of the plurality of first rectangular shaped Helmholtz resonator comprises a first neck defined between a first end wall extending from the respective inner wall and the first flange; and
each of the second rectangular shaped Helmholtz resonator comprises a second neck defined between a second end wall extending from the respective inner wall and the second flange.
